(19) United States
(12) Patent Application Publication
(10) Pub. No.: US 2017/0279692 A1
(43) Pub. Date: Sep. 28, 2017

(54) DEPLOYING A SERVICE FROM A SELECTED CLOUD SERVICE PROVIDER BASED ON AN EVALUATION OF MIGRATION ABILITY USING GRAPH ANALYTICS

(71) Applicant: CA, Inc., New York, NY (US)

(72) Inventors: Jaume Ferrarons Llagostera, Barcelona (ES); Smrati Gupta, Barcelona (ES); Victor Muntés Mulero, Barcelona (ES); Peter Brian Matthews, Berkhamsted (GB); Josep LIuís Larriba Pey, Barcelona (ES)

(73) Assignee: CA, Inc., New York, CA (US)

(21) Appl. No.: 15/079,284

(22) Filed: Mar. 24, 2016

(51) Int. Cl. H04L 12/26; G06F 9/445; G06F 17/30; H04L 29/08

(52) U.S. Cl. CPC H04L 43/045; H04L 67/16; H04L 67/10; H04L 67/32; G06F 8/60; H04L 67/34; G06F 17/30958

(57) ABSTRACT

A method includes performing by a processor of a server: receiving a requirement description of a service for a software application, generating a migration graph that comprises vertices representing candidate service providers for the service, respectively, identifying migration capability information between the vertices of the migration graph by connecting a portion of the vertices with edges, generating a centrality metric for each of the vertices of the migration graph based on the migration capability information and a number of edges terminating at the respective vertex, grading the candidate service providers based on one of the migration capability information and the centrality metric, and deploying the service using one of the candidate service providers responsive to grading the candidate service providers receiving an architecture description for a software application that identifies a plurality of generic services, receiving a requirement description for the software application that comprises respective values for a plurality of priority parameters for the software application, and generating a proposal that, for each of the plurality of generic services, identifies a specific cloud service for the respective generic service based on the requirement description.

### BACKGROUND

The present disclosure relates to computing systems, and, in particular, to application deployment in a cloud computing environment.

Software developers may use a variety of different services in developing a new software application. These services may come from different sources including cloud service providers. In some instances, a software developer may obtain all of the cloud services needed for a software application from a single cloud service provider. In other situations, however, a software developer may not be able to rely on a single cloud service provider to source all of the required cloud services for a particular application. Various tools exist that software developers may use to evaluate a service from a single cloud service provider. These tools may not be effective, however, when building an application with services from multiple cloud service providers. When an end user (e.g., an enterprise that makes use of software applications) intends to deploy an application that uses different cloud services, it may be faced with the challenge of the selection of cloud services in a way that meets its business and technical requirements. As described above, considering the variety of features offered by different vendors for many types of services, as well as the multiple types of services that may be provided, the end user may desire to use a set of services from different vendors to meet its requirements, e.g., legal, organizational, technical, financial, etc. As a result, there may be a two-fold, challenge for end users: the selection of cloud services meeting their demands and the consequences that the selection of these services may have in the future in a multi-cloud environment. As used herein, a multi-cloud environment is one in which a software application may use multiple cloud services that may be hosted by different cloud service providers. Deploying a software application in a multi-cloud environment with different cloud service(s) providers may entail many advantages, but may also increase the number of aspects that are user may take into account when selecting a particular cloud service. For example, it may be important to understand whether a user selects a cloud service that can be easily replaced by another cloud service from a different provider, for example, in case the original provider fails to fulfill Service Level Agreements (SLAs) or the requirements of a particular application change (e.g., scalability requirements) and the current service and provider cannot successfully meet the new requirements. Moreover, it is generally desirable that any such changes or migration between service providers be done with fewer disruption of services, preservation of desired features, etc. These in which a cloud service may be replaced, i.e., migrated from one cloud service provider to another cloud service provider, may depend on many different factors. As the number of services and providers grows, a comparison among a large number of services based on different criteria and taking into account the ease of migration of each service may make the selection of cloud services and cloud service providers more intricate.

### SUMMARY

In some embodiments of the inventive subject matter, a method comprises performing by a processor: receiving a requirement description of a service for a software application, generating a migration graph that comprises vertices representing candidate service providers for the service, respectively, identifying migration capability information between the vertices of the migration graph by connecting a portion of the vertices with edges, generating a centrality metric for each of the vertices of the migration graph based on the migration capability information and a number of edges terminating at the respective vertex, grading the candidate service providers based on one of the migration capability information and the centrality metric, and deploying the service using one of the candidate service providers responsive to grading the candidate service providers.

In other embodiments, a system comprises a processor and a memory coupled to the processor and comprising computer readable program code embodied in the memory that is executable by the processor to perform: receiving a requirement description of a service for a software application, generating a migration graph that comprises vertices representing candidate service providers for the service, respectively, identifying migration capability information between the vertices of the migration graph by connecting a portion of the vertices with edges, generating a centrality metric for each of the vertices of the migration graph based on the migration capability information and a number of edges terminating at the respective vertex, generating a migration metric based on the migration capability information, grading the candidate service providers based on each of the centrality metric, the migration metric, and a price metric, and deploying the service using one of the candidate service providers responsive to grading the candidate service providers.

In further embodiments, a computer program product, comprises a tangible computer readable storage medium comprising computer readable program code embodied in the medium that is executable by a processor to perform: receiving a requirement description of a service for a software application, generating a migration graph that comprises vertices representing candidate service providers for the service, respectively, identifying migration capability information between the vertices of the migration graph by connecting a portion of the vertices with edges, generating a centrality metric for each of the vertices of the migration graph based on the migration capability information and a number of edges terminating at the respective vertex, the centrality metric being generated using one of PageRank and Hyperlink-Induced Topic Search (HITS), generating a migration metric based on the migration capability information, grading the candidate service providers based on each of the centrality metric, the migration metric, and a price metric, and deploying the service using one of the candidate service providers responsive to grading the candidate service providers.

It is noted that aspects described with respect to one embodiment may be incorporated in different embodiments although not specifically described relative thereto. That is, all embodiments and/or features of any embodiments can be combined in any way and/or combination. Moreover, other methods, systems, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. It is further intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram of a system for deploying a service from a selected cloud service provider based on an evaluation of migration ability using graph analytics in accordance with some embodiments of the inventive subject matter;

FIG. 2 illustrates a data processing system that may be used to implement the MultiCloud advisor system of FIG. 1 in accordance with some embodiments of the inventive subject matter;

FIG. 3 is a block diagram that illustrates a software/hardware architecture for deploying a service from a selected cloud service provider based on an evaluation of migration ability using graph analytics in accordance with some embodiments of the present inventive subject matter;

FIG. 4 is a flowchart that illustrates operations for deploying a service from a selected cloud service provider based on an evaluation of migration ability using graph analytics in accordance with some embodiments of the inventive subject matter;

FIG. 5 is a table that illustrates cloud service requirements for various software applications in accordance with some embodiments of the inventive subject matter;

FIG. 6 is a table that illustrates capabilities for cloud services provided by various cloud service providers in accordance with some embodiments of the inventive subject matter;

FIG. 7 is a capability graph that illustrates relationships between software applications and services provided by cloud service providers in accordance with some embodiments of the inventive subject matter;

FIG. 8 is a migration graph that illustrates relationships between services provided by cloud service providers in accordance with some embodiments of the inventive subject matter;

FIG. 9 is the migration graph of FIG. 8 including PageRank centrality rank information for each of the vertices in accordance with some embodiments of the inventive subject matter;

FIG. 10 is a table that illustrates grades for various cloud service providers for multiple metrics in accordance with some embodiments of the inventive subject matter;

FIG. 11 is a table that illustrates a metric comparison matrix for various cloud service providers according to some embodiments of the inventive subject matter;

FIG. 12 is a table that illustrates first Eigen vectors for each of the metrics of FIG. 11 in accordance with some embodiments of the inventive subject matter;

FIG. 13 is a table that illustrates user preferences rankings for the metrics of FIGS. 11 and 12 in accordance with some embodiments of the inventive subject matter; and

FIG. 14 is a table that illustrates grades for the various cloud service providers based on tables of FIGS. 12 and 13 in accordance with some embodiments of the inventive subject matter.

### DETAILED DESCRIPTION

In the following detailed description, numerous specific details are set forth to provide a thorough understanding of embodiments of the present disclosure. However, it will be understood by those skilled in the art that the present invention may be practiced without these specific details. In some instances, well-known methods, procedures, components and circuits have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

As used herein, a “service” includes, but is not limited to, a software and/or hardware service, such as cloud services in which software, platforms, and infrastructure are provided remotely through, for example, the Internet. A service may be provided using Software as a Service (SaaS), Platform as a Service (PaaS), and/or Infrastructure as a Service (IaaS) delivery models. In the SaaS model, customers generally access software residing in the cloud using a thin client, such as a browser, for example. In the PaaS model, the customer typically creates and deploys the software in the cloud sometimes using tools, libraries, and routines provided through the cloud service provider. The cloud service provider may provide the network, servers, storage, and other tools used to host the customer's application(s). In the IaaS model, the cloud service provider provides physical and/or virtual machines along with hypervisor(s). The customer installs operating system images along with application software on the physical and/or virtual infrastructure provided by the cloud service provider.

As used herein, the term “data processing facility” includes, but it not limited to, a hardware element, firmware component, and/or software component. A data processing system may be configured with one or more data processing facilities.

As used herein, data are raw, unorganized facts that need to be processed. Data can be something simple and seemingly random and useless until it is organized. When data are processed, organized, structured or presented in a given context so as to make it useful, it is called content or information. Examples of content or information include, but are not limited to, word processing files, slide presentation program files, spreadsheet files, video files, audio files, picture files, and document exchange files.

Some embodiments of the inventive subject matter stem from a realization that a consumer of cloud services may have numerous criteria to consider when selecting a service provider for a cloud service including, but not limited to, how easy it may be to migrate between services provided by different service providers. According to some embodiments of the inventive subject matter, a MultiCloud decision support system (DSS) may receive a requirement description of a service for a software application and use graph analytics to generate a migration graph that comprises vertices that represent candidate service providers for the service and edges that represent migration capability information. One or more metrics may be generated based on the migration graph information to grade the candidate service providers. These grades can then be used to select one of the candidate service providers to deploy the service. In some embodiments of the inventive subject matter, the grades for the candidate service providers may be generated by using a Multi-Criteria Decision Model Algorithm (MCDMA) to process the metrics.

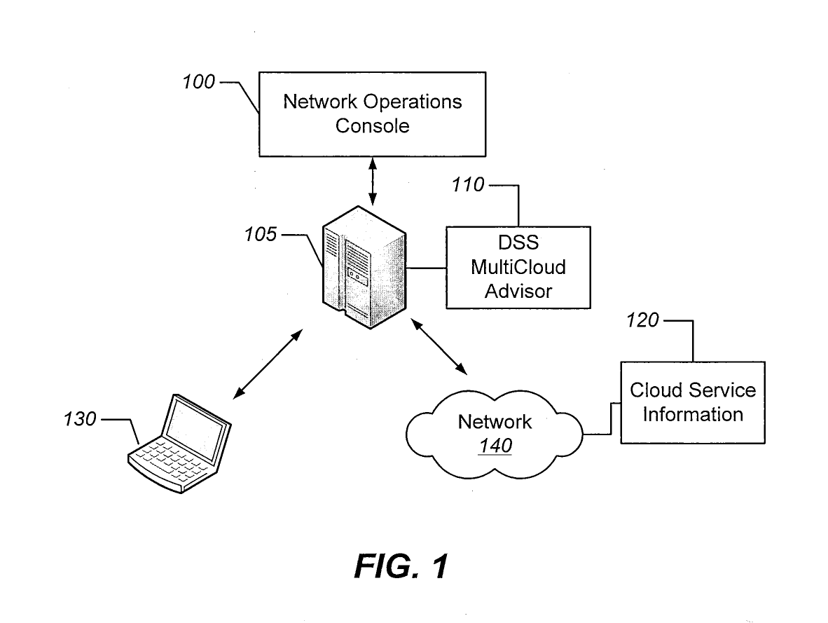

FIG. 1 is a block diagram of a system for deploying a service from a selected cloud service provider based on an evaluation of migration ability using graph analytics according to some embodiments of the inventive subject matter. A MultiCloud DSS server 105 is connected to a network operations console 100 through which software developers, administrators, or other types of personnel involved in managing and maintaining software applications may access the MultiCloud DSS server 105 to obtain proposals for selection and deployment of specific service(s) from one or more cloud service providers. The users of the MultiCloud DSS server 105 may facilitate the input of a requirement description that includes the desired specifications (e.g., features, performance capabilities, etc.) of cloud service(s) for the cloud service(s) to be compatible (e.g., fulfill the needs of the software application(s)) with the one or more software application(s). The requirement description information may be obtained from a variety of sources including, but not limited to, manuals, knowledge from users, and information repositories, such as cloud service information 120 that can be accessed via the network 140. Thus, the requirement description information may be compiled through both electronic access means as well as manual entry of information through, for example, the network operations console 100 and/or through mobile or portable devices 130. The MultiCloud DSS server 105 includes a DSS MultiCloud advisor module 110 and may access various Websites, databases, and other types of information stores represented in FIG. 1 as cloud service information 120 via the network 140 to obtain information regarding various specific cloud services and cloud service providers that may be candidates for providing the service(s) for one or more software applications. The DSS MultiCloud advisor module 110 uses the cloud service information 120 along with the requirement description to identify candidate service providers for each cloud service that may be used by each of the software applications.

A software application deployed in an enterprise may involve the deployment of one or more cloud services from one or more cloud service providers based on the requirements of the software application as explained above. When deploying a software application, an enterprise may foresee, for example, significant changes in the current requirements that may foreshadow a future need to replace one or more cloud services used by the software application to comply with the evolving requirements. As will be described in detail below, the MultiCloud DSS server 105 may be used to evaluate cloud service providers using graph analytic techniques to assess various metrics including, but not limited to, migration ability, price, and the like. An enterprise may, therefore, evaluate cloud service providers in terms of how easy it is to migrate services between service providers while taking into account other metrics like cost, performance, efficiency, etc.

As shown in FIG. 1, the connections between the MultiCloud DSS server 105 and the network operations console 100 and device(s) 130 may include wireless and/or wireline connections and may be direct or include one or more intervening local area networks, wide area networks, and/or the Internet. The network 140 may be a global network, such as the Internet or other publicly accessible network. Various elements of the network 140 may be interconnected by a wide area network, a local area network, an Intranet, and/or other private network, which may not be accessible by the general public. Thus, the communication network 140 may represent a combination of public and private networks or a virtual private network (VPN). The network 140 may be a wireless network, a wireline network, or may be a combination of both wireless and wireline networks.

Although FIG. 1 illustrates a system for deploying a service from a selected cloud service provider based on an evaluation of migration ability using graph analytics according to some embodiments of the inventive subject matter it will be understood that embodiments of the present invention are not limited to such configurations, but are intended to encompass any configuration capable of carrying out the operations described herein.

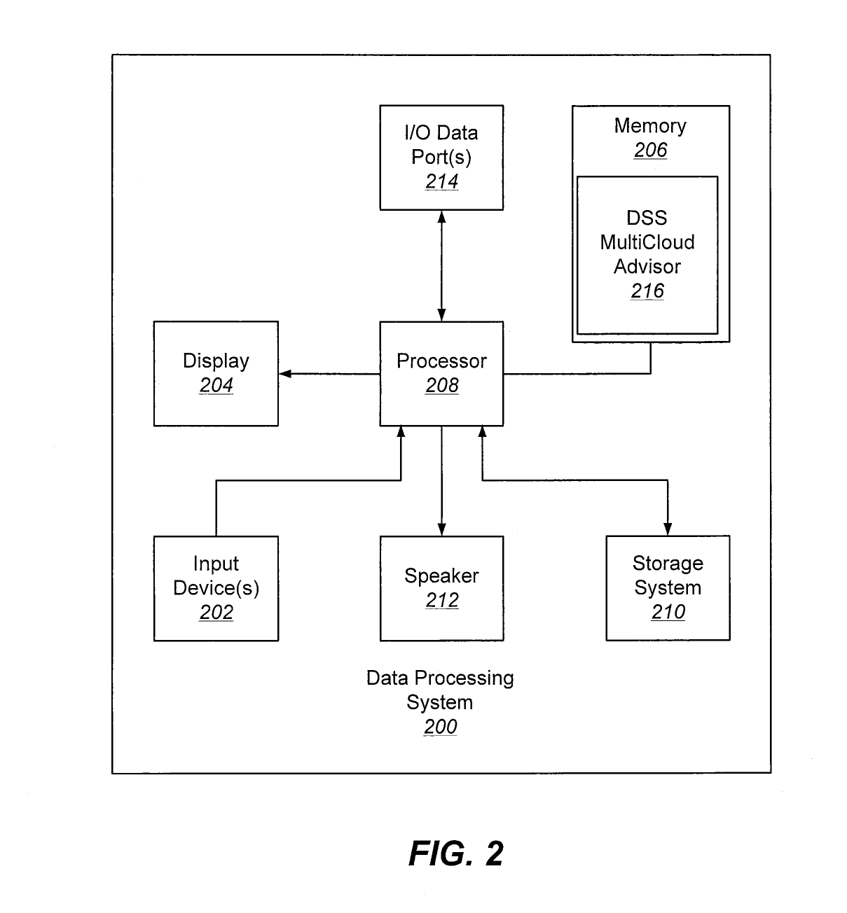

Referring now to FIG. 2, a data processing system 200 that may be used to implement the MultiCloud DSS server 105 of FIG. 1, in accordance with some embodiments of the inventive subject matter, comprises input device(s) 202, such as a keyboard or keypad, a display 204, and a memory 206 that communicate with a processor 208. The data processing system 200 may further include a storage system 210, a speaker 212, and an input/output (I/O) data port(s) 214 that also communicate with the processor 208. The storage system 210 may include removable and/or fixed media, such as floppy disks, ZIP drives, hard disks, or the like, as well as virtual storage, such as a RAMDISK. The I/O data port(s) 214 may be used to transfer information between the data processing system 200 and another computer system or a network (e.g., the Internet). These components may be conventional components, such as those used in many conventional computing devices, and their functionality, with respect to conventional operations, is generally known to those skilled in the art. The memory 206 may be configured with a DSS MultiCloud Advisor module 216 that may be configured to facilitate deployment of a service from a selected cloud service provider based on an evaluation of migration ability using graph analytics according to some embodiments of the inventive subject matter.

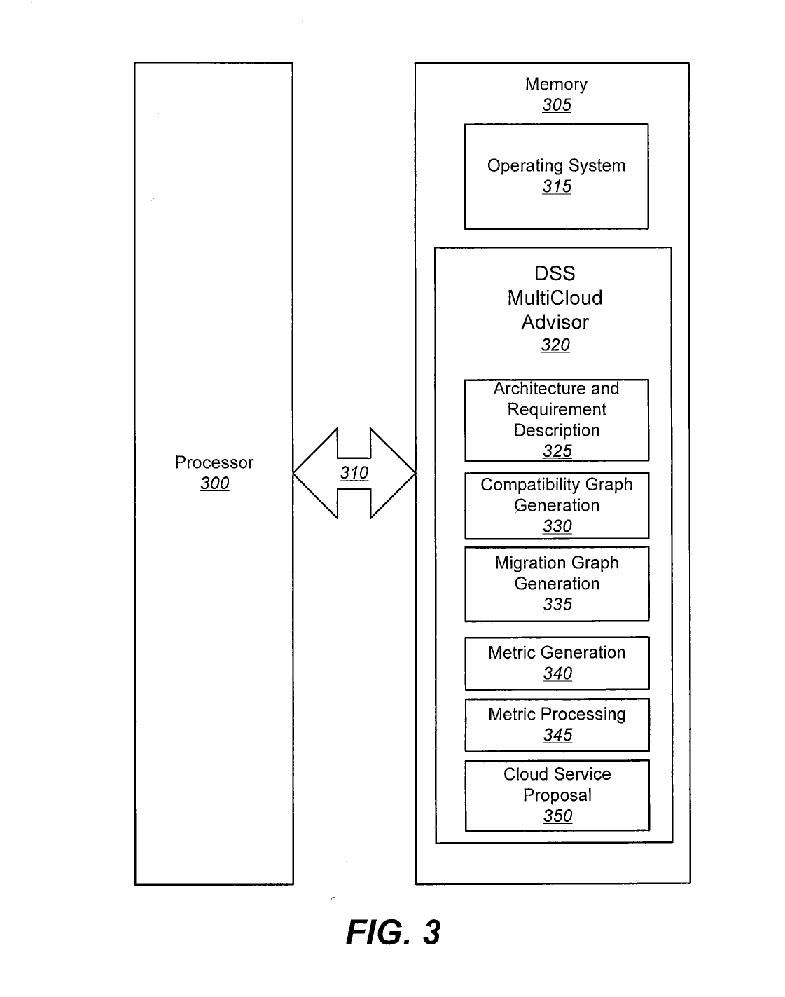

FIG. 3 illustrates a processor 300 and memory 305 that may be used in embodiments of data processing systems, such as the MultiCloud DSS server 105 of FIG. 1 and the data processing system 200 of FIG. 2, respectively, for facilitating deployment of a service from a selected cloud service provider based on an evaluation of migration ability using graph analytics according to some embodiments of the inventive subject matter. The processor 300 communicates with the memory 305 via an address/data bus 310. The processor 300 may be, for example, a commercially available or custom microprocessor. The memory 305 is representative of the one or more memory devices containing the software and data used for generating a proposal for selection of specific services from one or more cloud service providers in accordance with some embodiments of the inventive subject matter. The memory 305 may include, but is not limited to, the following types of devices: cache, ROM, PROM, EPROM, EEPROM, flash, SRAM, and DRAM.

As shown in FIG. 3, the memory 305 may contain up to two or more categories of software and/or data: an operating system 315 and a DSS MultiCloud advisor module 320. The operating system 315 generally controls the operation of the data processing system. In particular, the operating system 315 may manage the data processing system's software and/or hardware resources and may coordinate execution of programs by the processor 300.

The architecture and requirement description module 325 may be configured to receive and process requirement description for the software application. In some embodiments of the inventive subject matter, the architecture and requirement description module 325 may provide a user interface by which a user may input the requirement description. The requirement description includes the desired specifications (e.g., features, performance capabilities, etc.) of cloud service(s) for the cloud service(s) to be compatible or fulfill the needs of one or more software application(s). For example, a software application may require a cloud database as a service that is based on MySQL version 5.0 and above. The requirement description information may be obtained from a variety of sources including, but not limited to, manuals, knowledge from users, and information repositories, such as online information resources available via the Internet. As user interface may be provided to allow a user, such as a system administrator, to enter manually the requirement description information that may be obtained, for example from sources, such as users, manuals, and the like.

The compatibility graph generation module 330 may generate a compatibility graph for one or more software applications based on the requirement descriptions obtained via the architecture and requirement description module 325. The compatibility graph comprises vertices that represent candidate service providers for a service along with the software application(s). An edge is defined between a software application and a candidate service provider when the service provided by the candidate service provider satisfies the requirement description corresponding to the service for the software application. Thus, an edge in the compatibility graph conveys technical capability information that the service provided by the candidate service provider fulfills the technical requirements of the software application.

The migration graph generation module 335 may generate a migration graph from the compatibility for a particular software application that comprises vertices containing the candidate service providers that were connected by edges to the software application in the compatibility graph. The vertices representing the candidate service providers are connected by edges, which represent migration capability information between the services provided by the candidate service providers. Any candidate service provider connected to the software application vertex in the capability graph that is not capable of supporting a migration to service provided by another candidate service provider or is not capable of being migrated to from a service provided by another candidate service provider is not included in the migration graph.

The metric generation module 340 may be configured to generate one or more metrics based on the information contained in the migration graph. For example, the metric generation module 340 may generate a centrality metric for each of the vertices contained in the migration graph, which correspond go candidate service providers. In accordance with various embodiments of the inventive subject matter, the centrality metric may be generated using PageRank and/or Hyperlink-Induced Topic Search (HITS). The centrality metric may be indicative of the “popularity” of each node or vertex in that it is able to provide features that may be required of many applications and are offered by many different cloud services. As a result, a service provided by a candidate service provider with a higher centrality metric score may be viewed as easier to migrate from or to another candidate service provider. In addition to the centrality metric, other metrics may also be derived from the migration graph and/or generated from other information associated with the candidate service providers. For example,

The metric processing module 345 may be configured to grade the candidate service providers based on the one or more metrics obtained via the metric generation module 340. In some embodiments of the inventive subject matter, the metric processing module 345 may use a Multi-Criteria Decision Model Algorithm (MCDMA) to grade the various candidate service providers based on the one or more metrics.

The cloud service proposal module 350 may process the output of the metric processing module 345 in which the candidate service providers are graded with respect to the one or more metrics. The cloud service proposal module 350 may allow the end user to rank the metrics in level of importance so that the grades assigned to the candidate service providers reflect the priorities of the enterprise. A candidate service provider for a service can be selected based on the grades generated by the metric processing module 345 and deployed as a service for one or more of the software applications of the enterprise.

Although FIG. 3 illustrates hardware/software architectures that may be used in data processing systems, such as the MultiCloud DSS server 105 of FIG. 1 and the data processing system 200 of FIG. 2, respectively, for deploying a service from a selected cloud service provider based on an evaluation of migration ability using graph analytics, according to some embodiments of the inventive subject matter, it will be understood that the present invention is not limited to such a configuration but is intended to encompass any configuration capable of carrying out operations described herein

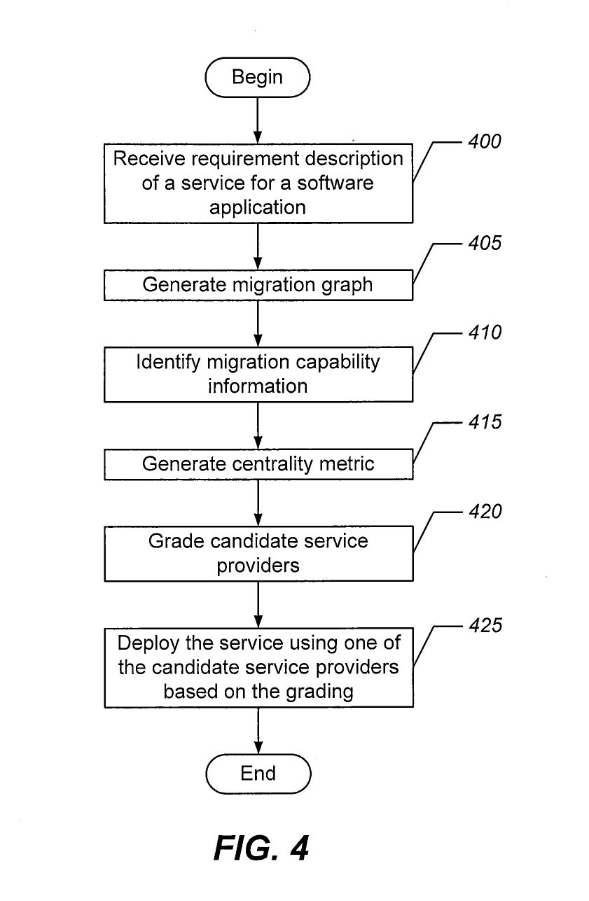

Computer program code for carrying out operations of data processing systems discussed above with respect to FIG. 4 may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality of the MultiCloud DSS server 105 of FIG. 1 and the data processing system 200 of FIG. 2, and/or the hardware/software architecture of FIG. 3 may each be implemented as a single processor system, a multi-processor system, a multi-core processor system, or even a network of stand-alone computer systems, in accordance with various embodiments of the inventive subject matter. Each of these processor/computer systems may be referred to as a “processor” or “data processing system.”

The data processing apparatus of FIGS. 1-3 may be used to facilitate the deployment of a service from a selected cloud service provider based on an evaluation of migration ability using graph analytics according to various embodiments described herein. These apparatus may be embodied as one or more enterprise, application, personal, pervasive and/or embedded computer systems and/or apparatus that are operable to receive, transmit, process and store data using any suitable combination of software, firmware and/or hardware and that may be standalone or interconnected by any public and/or private, real and/or virtual, wired and/or wireless network including all or a portion of the global communication network known as the Internet, and may include various types of tangible, non-transitory computer readable media. In particular, the memory 305 coupled to the processor 300 includes computer readable program code that, when executed by the respective processors, causes the respective processors to perform operations including one or more of the operations described herein with respect to FIGS. 4-14.

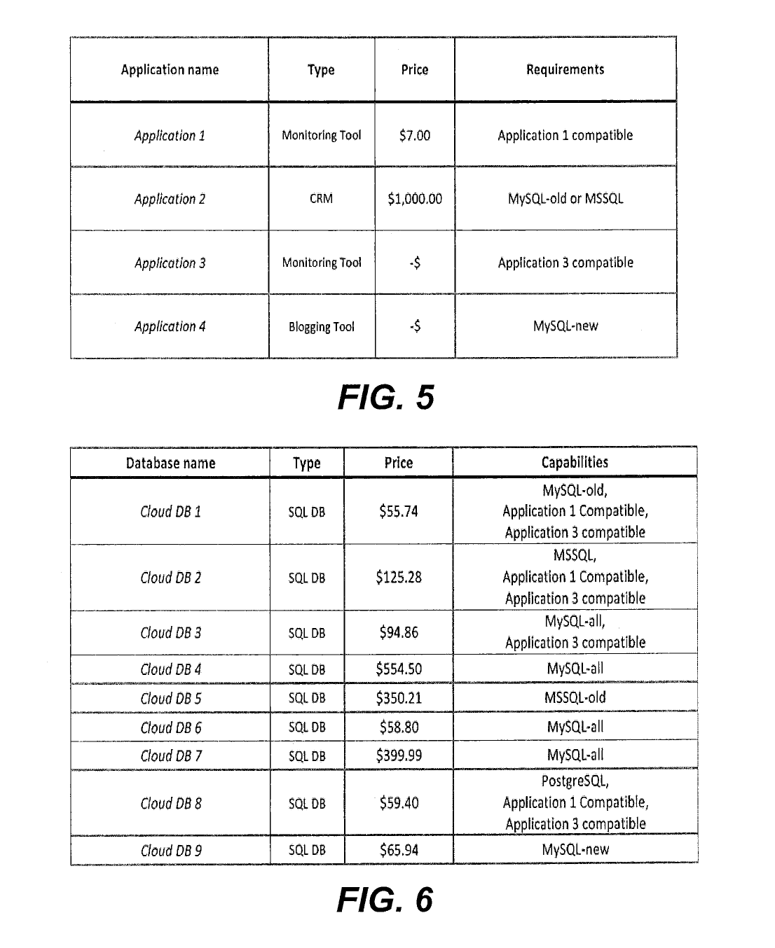

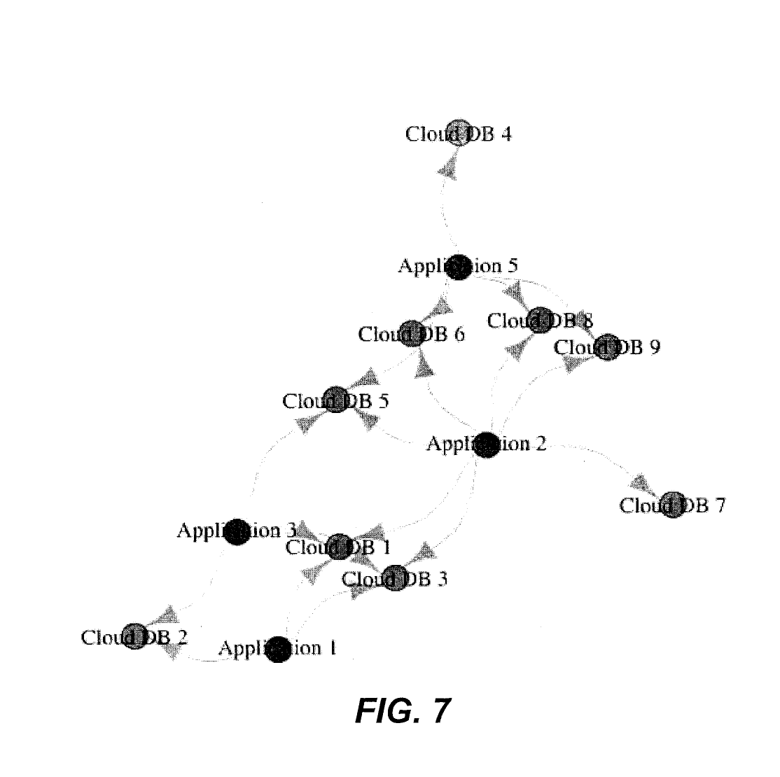

FIG. 4 is a flowchart that illustrates operations for deploying a service from a selected cloud service provider based on an evaluation of migration ability using graph analytics according to some embodiments of the inventive subject matter. Operations begin at block 400 where the DSS MultiCloud DSS server 105 receives the requirement description for one or more software applications. This is shown, for example, in the table of FIG. 5 where four applications—Application 1, Application 2, Application 3, and Application 4—are shown identifying their corresponding prices and database requirements. FIG. 6 shows the capabilities of various candidate service providers for a cloud database service along with their respective prices. Each of the candidate service providers in FIG. 6 provides an SQL database. At block 405 a migration graph is generated using the compatibility graph module 330 and the migration graph generation module 335. The migration graph is generated based on the requirement description information shown in FIGS. 5 and 6 for a particular service type. If a software application requires two different cloud service types—a SQL database and a compute instance, for example—then two different migration graphs may be generated: one that has the nodes for candidate service providers for the SQL database and another that has the nodes for candidate service providers for the compute instance. In some embodiments, the migration graph is generated by creating a compatibility graph as shown in FIG. 7 based on the requirement description information from FIGS. 5 and 6. As shown in FIG. 7, the compatibility graph generation module 330 creates nodes for each of the four software applications of FIG. 5 and connects them to nodes corresponding to candidate service providers for a cloud database service listed in FIG. 6. An edge is formed between a node or vertex representing a software application and a node or vertex representing a candidate service provider when the candidate service provider can fulfill the requirements of the software application.

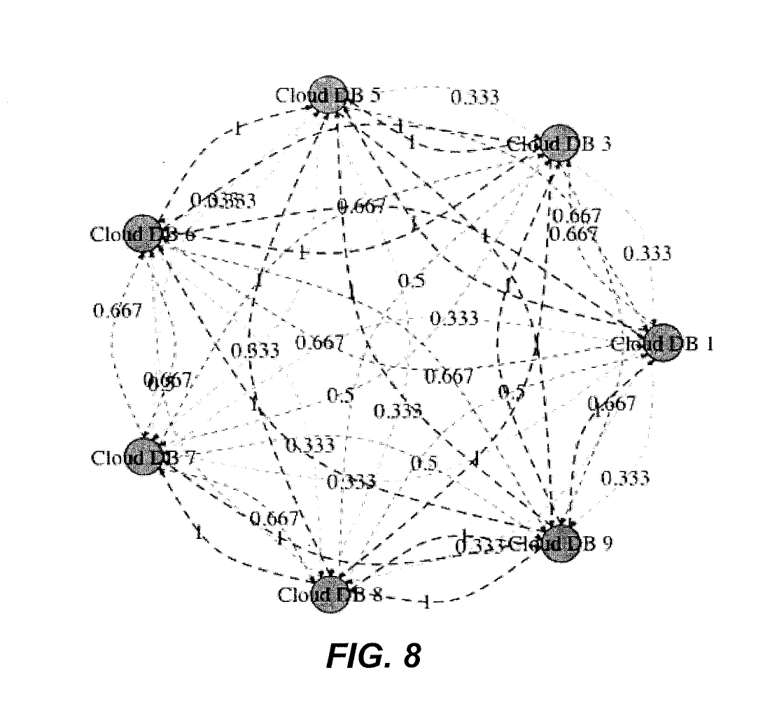

Operations continue at block 410 where migration capability information is identified by connecting those candidate service provider vertices with edges indicating that it is possible to migrate between the two candidate service providers. FIG. 8 is an example migration graph for Application 2 of FIG. 7. In accordance with various embodiments of the inventive subject matter, the seven candidate service providers are connected with edges including weights reflecting the ease of which it is to migrate from one cloud service to another provided by the respective candidate service providers. Moreover, in some embodiments, the edges may be directed indicating different weights depending on the direction of migration or that migration is only possible in one direction. Non-directed edges indicate or presume that the ease of migration is possible and equal in both directions. In the example of FIG. 8, the weights assigned to each of the edges is an indication of the ease of migration of the service from one candidate service provider to another candidate service provider. The ease of migration may be computed as a ratio of the number of software applications that are operable with the service provided at both candidate service providers to the total number of applications operable with the service at the candidate service provider being migrated from. This information may be obtained from the compatibility graph, for example, which includes all of the relevant software applications for the enterprise. In the present example, a system administrator may decide that a monitoring tool software application is not presently needed with Application 2, but it may be needed in the future. As a result, it would be better to have cloud services provided by cloud service providers that are interoperable with a greater number of other software applications such that if a decision is made to migrate between service providers in the future there is less likely to be compatibility issues. In other embodiments, ease of migration may be defined in other ways, such as the number of read/write operations are required (in the case of a database service), the availability of a migration tool provided by the service provider, etc. In the example described above, the ease of migration is not symmetric resulting in directed edges in the migration graph.

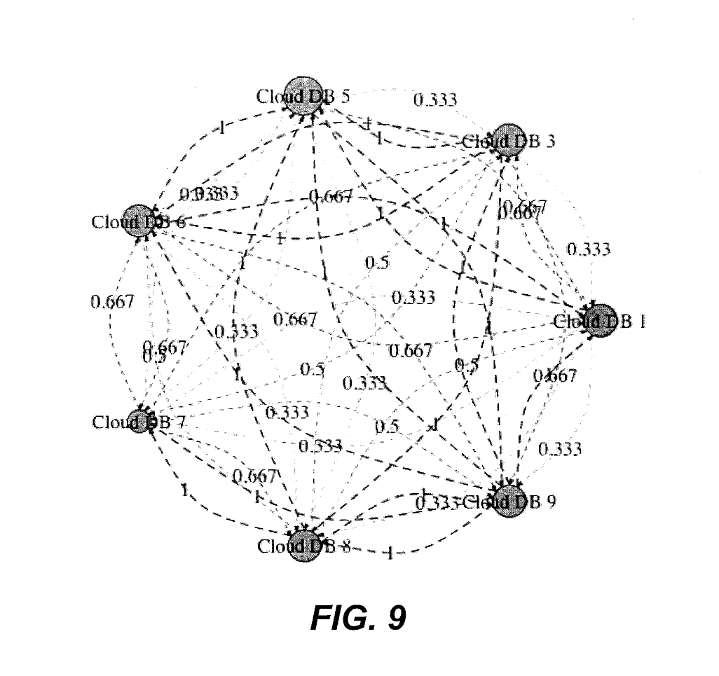

Returning to FIG. 4, at block 410, the metric generation module 340 generates a centrality metric is generated for each of the nodes or vertices in the migration graph. The centrality metric is an indication of an “importance” of the node in the migration graph and can be generated using for example, PageRank and/or Hyperlink-Induced Topic Search (HITS). The centrality metric may be viewed as a measure of the degree of interoperability of the candidate service providers for a particular service and the ease of migration between the cloud services provided by the candidate service providers. Using PageRank as an example, the generated centrality metric may be indicative of the “popularity” of each node or vertex in that it is able to provide features that may be required of many applications and are offered by many different cloud services. As a result, a service provided by a candidate service provider with a higher PageRank centrality metric score may be viewed as easier to migrate from or to another candidate service provider. The HITS algorithm may provide two values to each node or vertex in the migration graph describing the goodness of a given node as a hub or authority within the graph. Hubs are nodes that have strong links pointing out. Thus, a high value as a Hub means that it is easy to migrate out of the service provided by the candidate service provider. The authority of a node is linked to the strength of the incoming links, which has a similar meaning as the PageRank value, i.e., it helps to understand how easy it is to migrate to a particular cloud service provided by a cloud service provider and the level of popularity of the features provided by the cloud service. FIG. 9 illustrates the results of a PageRank centrality metric generation for the nodes in the migration graph of FIG. 8. The nodes corresponding to the candidate service providers are shown with sizes reflecting their respective PageRank centrality metric scores relative to each other. As shown in FIG. 9, Cloud DB7 is the smallest node having the lowest migration popularity value. This is because the edges arriving at the Cloud DB7 node have the lowest weights, i.e., migration ease values pointing to this node are low. The Cloud DB5 node is the largest node and has the highest PageRank centrality metric score because the edges pointing to it have high scores meaning it is generally easy to migrate to.

The metric generation module 340 may also generate other metrics in addition to the centrality metric in accordance with various embodiments of the inventive subject matter. One such metric may be maximum ease of migration, which may be defined as the maximum ease of migration value, which may be normalized, outgoing from a given node in the migration graph. Maximum ease of migration characterizes how easy it is to migrate out from a service provided by a candidate service provider according to their compatibilities in the best case scenario, i.e., when a candidate service provider is replaced by another with the highest ease of migration value. The metric generation module 340 may also generate a price or cost metric for the various candidate service providers.

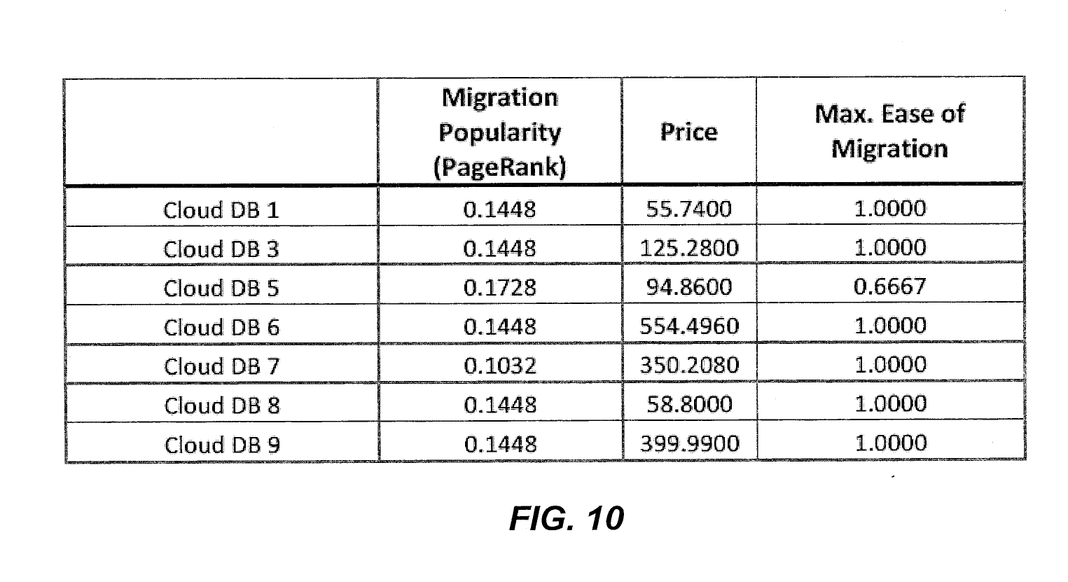

Returning to FIG. 4, the metric processing module 345 may use the centrality metric and/or any other metrics generated by the metric generation module 340 to grade the candidate service providers from the migration graph at block 420. As shown in FIG. 10, each of the candidate service providers is graded based on the PageRank centrality metric, the price metric, and the maximum ease of migration metric. In some embodiments, a user or system administrator may review these scores to select a candidate service provider to use to deploy the service for the software application at block 425. In other embodiments, a user or system administrator may process the metric scores for the various candidate service providers further using MCDMA to select a candidate service provider to provide the cloud service for the software application.

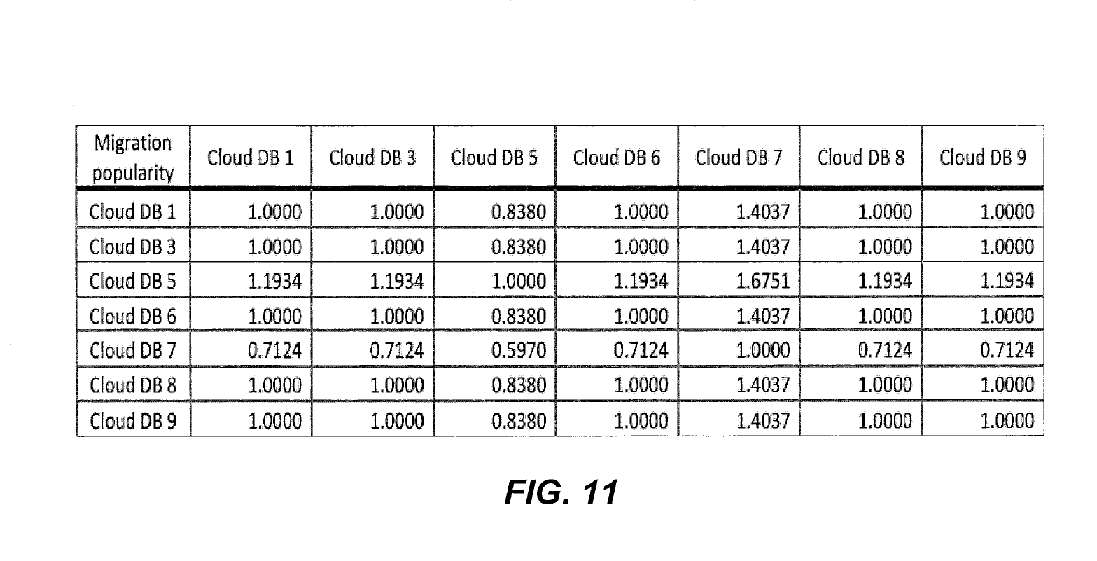

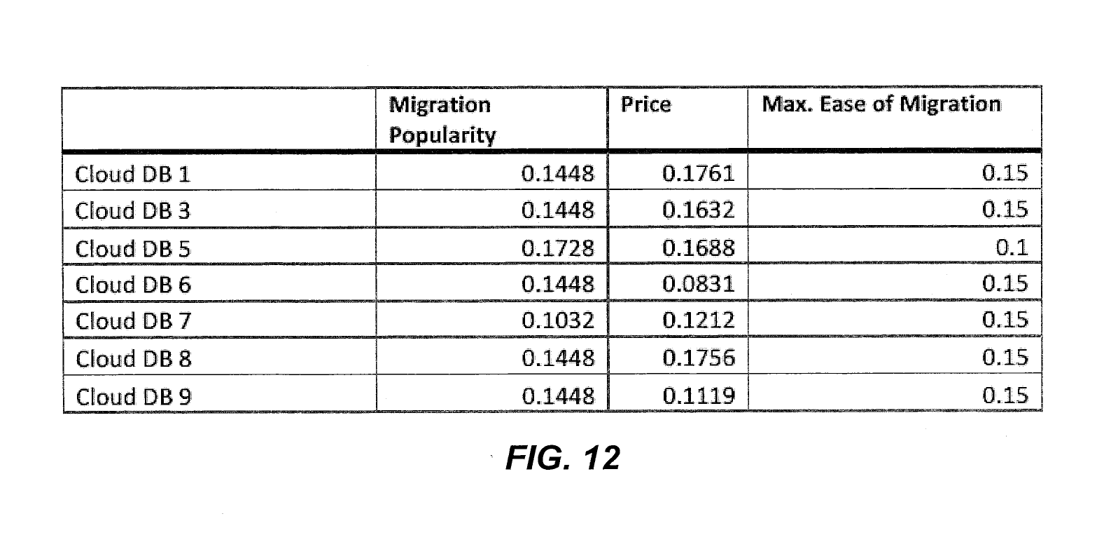

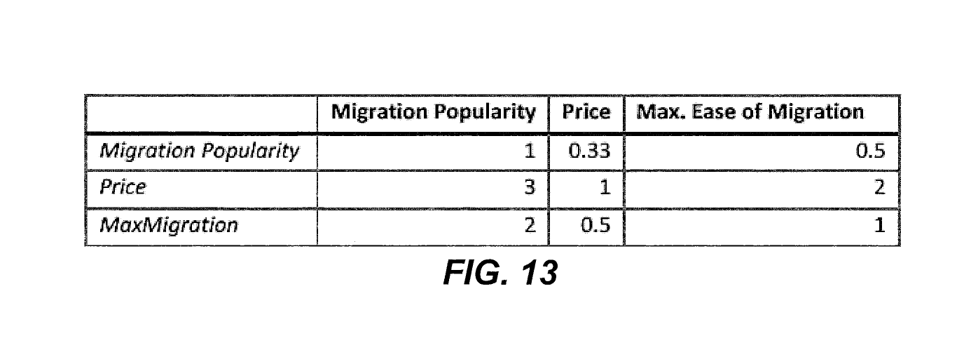

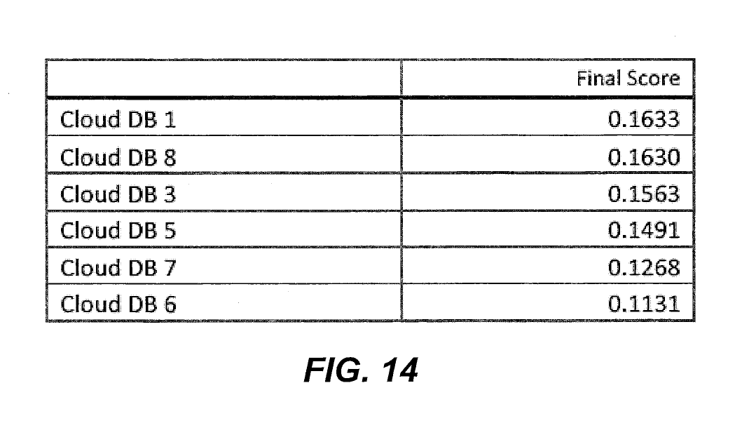

In some embodiments of the inventive concept, Analytic Hierarchy Process (AHP) may be used to aggregate the metric information for the various candidate service providers to generate a final score for each of the candidate service providers. FIG. 11 shows a comparison matrix for the candidate service providers that are generated for the PageRank centrality metric. Similar matrices can be generated for the price and maximum ease of migration metrics. Entries in the comparison matrix are generated by using the formula Mi,j=MPi/MPj where Mi,j is the value of in the ith row and jth column in the table of FIG. 11 and MPi is the PageRank value for the ith candidate service provider in FIG. 10. The first Eigen vector of each of the comparison matrices is computed and normalized as shown in FIG. 12. The user or system administrator may define preference rankings for the various metrics depending on what factors are most important to the enterprise. These preference rankings are shown in FIG. 13 for the three metrics in the present example. As can be seen in FIG. 13, offering competitive prices is three times more important than having a good migration popularity (PageRank centrality metric). The first Eigen vector, which may be normalized, of the preference matrix of FIG. 13 may be generated, which in the present example is: Preference vector (0.1634241, 0.5396146, 0.2969613). The first Eigen vector of the preference matrix may be multiplied with the first Eigen vector of the comparison matrix to generate a set of final scores for the candidate service providers, which are shown in FIG. 14. Based on the preferences defined in FIG. 13, the best ranked service is Cloud DB1 followed by Cloud DB8. These results are based on Cloud DB1 having the best price, highest maximum ease of migration, and an average migration popularity (PageRank centrality metric). Cloud DB8 has the second best price and the same values as Cloud DB1 for the other metrics. A user or system administrator may change the values in the preference matrix of FIG. 13 to determine which candidate service provider may be preferred if the enterprise's preferences change relative to what metrics are considered most important.

The embodiments of methods, systems, and computer program products described herein may provide a DSS for use in a multi-cloud environment to evaluate cloud service providers using graph analytic techniques to assess various metrics including, but not limited to, migration ability, price, and the like. Because of the complexity of evaluating multiple cloud service providers across multiple metrics, the embodiments of the DSS may save enterprises time and cost in performing such analyses and may increase the effectiveness of the services purchased by an enterprise by choosing service providers for deployment that better satisfy those metrics that are more important to the enterprise. Moreover, by including a metric, such as migration feasibility, in the analysis, an enterprise can reduce the risk of being locked into a particular service provider as the enterprise's needs evolve over time. Thus, embodiments of the present inventive subject matter provide a mechanism that allows a system administrator or architect to select service providers that may provide the greatest long term flexibility in deploying a service via a service provider for a software application that can be easily migrated from or to, which may reduce costs in the long term by reducing the number of additional resources that may be required to change service providers, e.g., processor(s), memory, network elements, and the like, even if the service provider may not be the lowest cost alternative initially.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

That which is claimed:

1. A method, comprising:
performing by a processor:
receiving a requirement description of a service for a software application;
generating a migration graph that comprises vertices representing candidate service providers for the service, respectively;
identifying migration capability information between the vertices of the migration graph by connecting a portion of the vertices with edges;
generating a centrality metric for each of the vertices of the migration graph based on the migration capability information and a number of edges terminating at the respective vertex;
grading the candidate service providers based on one of the migration capability information and the centrality metric; and
deploying the service using one of the candidate service providers responsive to grading the candidate service providers.

2. The method of claim 1, wherein receiving a requirement description of the service for the software application comprises receiving a plurality of requirement descriptions of the service for a plurality of software applications, the plurality of software applications comprising the software application; and
wherein generating the migration graph comprises:
generating a compatibility graph that comprises vertices respectively representing the candidate service providers for the service and a plurality of software applications; and
identifying technical capability information between vertices of the compatibility graph by connecting each of the vertices of the compatibility graph corresponding to the plurality of software applications to those vertices of the compatibility graph corresponding to the candidate service providers that satisfy the requirement description for the respective one of the software applications with edges;
selecting the candidate service providers for the service as the candidate service providers whose corresponding vertices are connected with edges to the vertex corresponding to the software application in the compatibility graph; and
eliminating any of the candidate service providers that were selected for which it is not possible to migrate the service to or from another one of the candidate service providers that were selected.

3. The method of claim 2, wherein each of the edges in the migration graph has a weight and a direction associated therewith.

4. The method of claim 3, wherein the weight comprises an ease of migration indicium represented as a comparison between a number of input/output operations associated with one of the candidate service providers being migrated from and a number of input/output operations associated with one of the candidate service providers being migrated to.

5. The method of claim 3, wherein the weight comprises an ease of migration indicium represented as a ratio of a first number of the plurality of software applications having corresponding vertices in the compatibility graph that are connected to vertices corresponding to one of the candidate service providers being migrated from and to one of the candidate service providers being migrated to, respectively, to a second number of the plurality of software applications having corresponding vertices in the compatibility graph that are connected to the vertex corresponding to the one of the candidate service providers being migrated from.

6. The method of claim 5, wherein generating the centrality metric for each of the vertices of the migration graph comprises:
using Hyperlink-Induced Topic Search (HITS) to generate the centrality metric for each of the vertices of the migration graph based on the number of edges terminating at the respective vertex and the ease of migration indicium for each of the respective edges terminating at the respective vertex.

7. The method of claim 5, wherein generating the centrality metric for each of the vertices of the migration graph comprises:
using PageRank to generate the centrality metric for each of the vertices of the migration graph based on the number of edges terminating at the respective vertex and the ease of migration indicium for each of the respective edges terminating at the respective vertex.

8. The method of claim 7, wherein grading the candidate service providers based on one of the migration capability information and the centrality metric comprises:
generating a maximum ease of migration metric for each of the vertices of the migration graph, the maximum ease of migration metric comprising the maximum ease of migration indicium for an edge directed out from the respective vertex; and
grading the candidate service providers based on the maximum ease of migration metric.

9. The method of claim 8, wherein grading the candidate service providers based on one of the migration capability information and the centrality metric comprises grading the candidate services based on each of the maximum ease of migration metric, the centrality metric generated using PageRank, and a price metric.

10. The method of claim 9, wherein deploying the service using one of the candidate service providers responsive to grading the candidate service providers comprises:
generating a first comparison matrix for the candidate service providers based on the maximum ease of migration metric;
generating a second comparison matrix for the candidate service providers based on the centrality metric generated using PageRank; and
generating a third comparison matrix for the candidate service providers based on the price metric.

11. The method of claim 10, further comprising:
generating the first Eigen vector of the first comparison matrix;
generating the first Eigen vector of the second comparison matrix; and
generating the first Eigen vector of the third comparison matrix;

12. The method of claim 11, further comprising:
receiving a preference ranking for each of the maximum ease of migration metric, the centrality metric generated using PageRank, and the price metric; and
generating a preference matrix based on the received preference rankings.

13. The method of claim 12, further comprising:
generating the first Eigen vector of the preference matrix;
multiplying the first Eigen vector of the preference matrix with each of the first Eigen vector of the first comparison matrix, the first Eigen vector of the second comparison matrix, and the first Eigen vector of the third comparison matrix to generate a plurality of final scores corresponding to the candidate service providers, respectively; and
deploying the service based on the plurality of final scores.

14. A system, comprising:
a processor; and
a memory coupled to the processor and comprising computer readable program code embodied in the memory that is executable by the processor to perform:
receiving a requirement description of a service for a software application;
generating a migration graph that comprises vertices representing candidate service providers for the service, respectively;
identifying migration capability information between the vertices of the migration graph by connecting a portion of the vertices with edges;
generating a centrality metric for each of the vertices of the migration graph based on the migration capability information and a number of edges terminating at the respective vertex;
generating a migration metric based on the migration capability information;
grading the candidate service providers based on each of the centrality metric, the migration metric, and a price metric; and
deploying the service using one of the candidate service providers responsive to grading the candidate service providers.

15. The system of claim 14, wherein deploying the service using one of the candidate service providers responsive to grading the candidate service providers comprises:
generating a second comparison matrix for the candidate service providers based on the centrality metric
generating a first comparison matrix for the candidate service providers based on the migration metric; and
generating a third comparison matrix for the candidate service providers based on the price metric.

16. The system of claim 15, further comprising:
generating the first Eigen vector of the first comparison matrix;
generating the first Eigen vector of the second comparison matrix; and
generating the first Eigen vector of the third comparison matrix;

17. The system of claim 16, further comprising:
receiving a preference ranking for each of the centrality metric, the migration metric, and the price metric; and
generating a preference matrix based on the received preference rankings.

18. The system of claim 17, further comprising:
generating the first Eigen vector of the preference matrix;
multiplying the first Eigen vector of the preference matrix with each of the first Eigen vector of the first comparison matrix, the first Eigen vector of the second comparison matrix, and the first Eigen vector of the third comparison matrix to generate a plurality of final scores corresponding to the candidate service providers, respectively; and
deploying the service based on the plurality of final scores.

19. A computer program product, comprising:
a tangible computer readable storage medium comprising computer readable program code embodied in the medium that is executable by a processor to perform:
receiving a requirement description of a service for a software application;
generating a migration graph that comprises vertices representing candidate service providers for the service, respectively;
identifying migration capability information between the vertices of the migration graph by connecting a portion of the vertices with edges;
generating a centrality metric for each of the vertices of the migration graph based on the migration capability information and a number of edges terminating at the respective vertex, the centrality metric being generated using one of PageRank and Hyperlink-Induced Topic Search (HITS);
generating a migration metric based on the migration capability information;
grading the candidate service providers based on each of the centrality metric, the migration metric, and a price metric; and
deploying the service using one of the candidate service providers responsive to grading the candidate service providers.

20. The computer program product of claim 19, further comprising:
using an Analytic Hierarchy Process (AHP) to aggregate the centrality metric, the migration metric, and the price metric and to generate a plurality of scores corresponding to the candidate service providers, respectively; and
wherein deploying the service comprises:
deploying the service based on the plurality of scores.
